(19) United States
(12) Patent Application Publication
(10) Pub. No.: US 2011/0101189 A1
(43) Pub. Date: May 5, 2011

(54) Mounting Device for Internal Circlip

(75) Inventors: Hongyuan Hu, Zhejiang (CN); Xiaofeng Wu, Zhejiang (CN)

(73) Assignee: XIAOHUA XU, Dongyang, Zhejiang (CN)

(21) Appl. No.: 12/995,271

(22) PCT Filed: Mar. 13, 2009
(86) PCT No.: PCT/CN09/70782

§ 371 Date: Nov. 30, 2010

(30) Foreign Application Priority Data
Jun. 10, 2008 (CN) 200810062412.2

(51) Int. Cl. F16M 13/00

(52) U.S. Cl. 248/309.1

(57) ABSTRACT

A mounting device for internal circlip comprises a device frame composed of a base board, a cylinder fixation board and at least two perpendicular sliding guides located between the base board and the cylinder fixation board and fixed thereof; a core rod fixation board and a sleeve fixation board being movable on the at least two sliding guides, the core rod fixation board being above the sleeve fixation board, at least two compression springs being located thereof; a cylinder fixed on the cylinder fixation board, a piston rod of the cylinder passing through the cylinder fixation board being fixed on top of a circlip core rod, the circlip core rod and the core rod fixation board being fixed together and a bottom of the circlip core rod extending to a top of the sleeve fixation board; a sleeve coaxial with the circlip core rod being fixed on the top of the sleeve fixation board, the sleeve having a inner cone hole with a big top opening and a small bottom opening, a bottom of the circlip core rod can pass through the small bottom opening of the inner cone hole, and an orientation board for a work piece being fixed on the base board at where is under and aimed at the sleeve. The device of the invention has good guide performance, and it could ensure success mounting of the circlip and could be operated conveniently.

### FIELD OF THE INVENTION

This invention is a mounting device for internal circlip. It belongs to circlip mounting device area.

### DESCRIPTION OF THE PRIOR ART

In some of the motor assembly structures, there is a method to use internal circlip inside the motor to fix the position of the end cover, that is, to form a groove inside the motor and mount the circlip afterwards. Firstly put the contracted circlip in the motor and when the circlip reaches to the groove it will stretch out with its own elastic force.

Someone proposes a press mounting device of internal circlip (publication number: CN2834799Y) including the base. On top of the base it is the upper die head driven by a cylinder and at the bottom of the base (opposite the upper die head) it is the work piece positioning base. There is a guiding sleeve in the device with a matching cavity shaped like a wedge.

Above work piece to some extent reduces the labor intensity but there are some problems during mounting: 1. Upper die head is only driven by the cylinder without any auxiliary guide. So it is easy for the circlip to deviate. 2. Pre-compression of the work piece is impossible.

### SUMMARY OF THE INVENTION

It is an object of the present invention is to provide a mounting device for internal circlip with excellent guiding effect and flexibility to avoid above problems such as no auxiliary guide/pre-compression and deviation.

The above and other related objects are attained by a mounting device for internal circlip comprising:
a device frame composed of a base board, a cylinder fixation board and at least two perpendicular sliding guides located between the base board and the cylinder fixation board and fixed thereof;
a core rod fixation board and a sleeve fixation board being movable on the at least two sliding guides, the core rod fixation board being above the sleeve fixation board, at least two compression springs being located thereof;
a cylinder fixed on the cylinder fixation board, a piston rod of the cylinder passing through the cylinder fixation board being fixed on top of a circlip core rod, the circlip core rod and the core rod fixation board being fixed together and a bottom of the circlip core rod extending to a top of the sleeve fixation board;
a sleeve coaxial with the circlip core rod being fixed on the top of the sleeve fixation board, the sleeve having a inner cone hole with a big top opening and a small bottom opening, a bottom of the circlip core rod can pass through the small bottom opening of the inner cone hole, and an orientation board for a work piece being fixed on the base board at where is under and aimed at the sleeve.

Before mounting, put the circlip inside the sleeve and put a work piece such as an electromotor casing on the orientation board, start the cylinder and the piston rod will push the circlip core rod and core rod fixation board to move downwards along the sliding guide. The sleeve fixation board will also move downwards under the action of the compression spring. The bottom of the sleeve will firstly contact the top surface of the work piece and pre-compress the work piece, the inner cone hole of the sleeve and the internal chamber of the work piece will perforate. The circlip core rod keeps moving downwards under the drive of the piston rod and its bottom will contact the circlip end face and press the circlip to the bottom of the inner cone hole of the sleeve. The circlip will contract as a result. With the continuous movement of the circlip core rod, the contracted circlip will be moved to the groove of the work piece and stretched out under its own elastic force. When the cylinder returns, it will repeat the above movement.

A circlip storage is provided on the top surface of the sleeve fixation board beside the sleeve, the circlip storage has a guide board matching a opening of the circlip, a feeding board having a smaller thickness than the circlip axial is movable between the guide board and the sleeve fixation board, the sleeve has an entrance allowing the feeding board to insert. A number of circlips can be pre-stored in the circlip storage so as to increase efficiency. The feeding board can position the circlips to make them orderly pile in the circlip storage.

The middle of said circlip core rod is provided with an annular step surface, which can contact with the top surface of the sleeve. The annular step surface can contact to the top surface of the sleeve so as to limit the down stroke of the circlip core rod and to prevent the circlip core rod from over effect with the inner cone hole of the sleeve. So it protects the device (prolong its service life) and the parts of the work piece.

The bottom of the sleeve forms an edge rounding with an outer cone shape. The bottom of the sleeve can insert in the work piece and close to the top of the groove, and the circlip will leave the inner cone hole of the sleeve by the thrust of the circlip core rod and directly enter the groove.

The bottom of said circlip core rod forms an annular convex shoulder having an outer diameter matching the inner diameter of a contracted same of the circlip.

The inner cone hole of the sleeve has a cylindrical section at the big top opening and a cylindrical section at the small bottom opening The cylindrical section at the big top opening make it easy for the circlip to enter in the inner cone hole of the sleeve and the cylindrical section at the small bottom opening make it easy to form a transition between the inner cone hole and the work piece and easy for the circlip to enter the groove.

The bottom of said circlip core rod forms a cavity and the top of the circlip core rod is connected with the piston rod of the cylinder by screw connection. The cavity is to ensure the axis of work piece is placed in the cavity when mounting the circlip to prevent the axis of work piece from obstructing the descending of the circlip core rod. It also prevents the circlip core rod from damaging the axis of work piece.

The core rod fixation board has a core rod mounting hole , the circlip core rod has a shoulder, the circlip core rod is put in the core rod mounting hole, then is fixed with the core rod fixation board together by bolts. The sleeve fixation board has a sleeve mounting hole, the sleeve has a shoulder, the sleeve is put in the outer case mounting hole ,then is fixed with the sleeve fixation board together by bolts.

Therefore, this invention has an excellent guiding effect to ensure the circlip can be easily mounted.

### BRIEF DESCRIPTION OF THE DRAWINGS

FIG. 1 is a cutaway view of the invention;

FIG. 2 is an enlarged view of part A of FIG. 1;

FIG. 3 is a top view of the circlip storage.

### DETAILED DESCRIPTION OF THE INVENTION

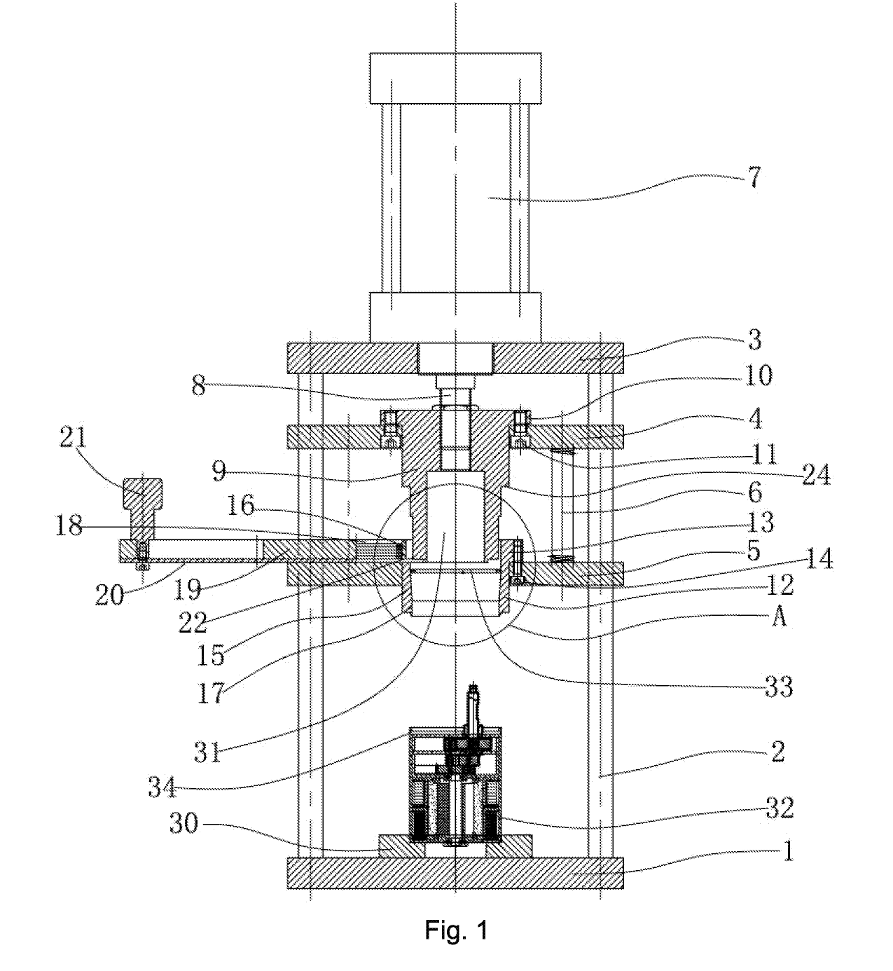

As shown in FIG. 1, a mounting device for internal circlip includes a device frame composed of a base board 1, a cylinder fixation board 3 and two perpendicular sliding guides 2 located between the base board 1 and the cylinder fixation board 3 and fixed thereof A core rod fixation board 4 and a sleeve fixation board 5 are movable on the two sliding guides 2. The core rod fixation board 4 is above the sleeve fixation board 5. Two compression springs 6 are located between the core rod fixation board 4 and the sleeve fixation board 5.

A cylinder 7 is fixed on the cylinder fixation board 3. A piston rod 8 of the cylinder 7 passes through the cylinder fixation board 3 and then fix a top of a circlip core rod 9 through thread. The core rod fixation board 4 has a core rod mounting hole, the circlip core rod 9 forms a shoulder 10, the circlip core rod 9 is put in the core rod mounting hole, then is fixed with the core rod fixation board 4 together by bolts 11. A bottom of the circlip core rod 9 extends to a top of the sleeve fixation board 5.

A sleeve 12 coaxial with the circlip core rod 9 is fixed on the top of the sleeve fixation board 5. The sleeve fixation board 5 has a sleeve mounting hole. The sleeve 12 has a shoulder 13. The sleeve 12 is put in the sleeve mounting hole, then is fixed with sleeve fixation board 5 together by bolts 14.

The sleeve 12 having an inner cone hole 15 with a big top opening and a small bottom opening. The cone angle of the inner cone hole 15 is 4° . The inner cone hole 15 of the sleeve 12 has a cylindrical section 16 at the big top opening and a cylindrical section 17 at the small bottom opening The bottom of the circlip core rod can pass through the small bottom opening of the inner cone hole.

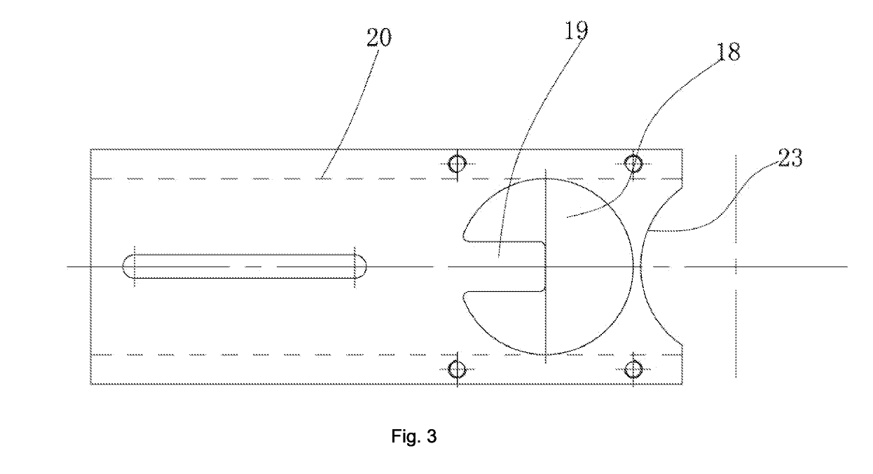

As shown in FIG. 3, a circlip storage 18 is provided on the top surface of the sleeve fixation board 5 beside the sleeve 12. The circlip storage 18 has a guide board 19 matching an opening of the circlip. A feeding board 20 has a smaller thickness than the circlip axial is movable between the guide board 19 and the sleeve fixation board 5. The front side of the feeding broad 20 forms a curved mouth 23. And the outside of the feeding broad 20 has a handle 21. The sleeve 12 has an entrance 12 allowing the feeding board 20 to insert and one circlip to go through.

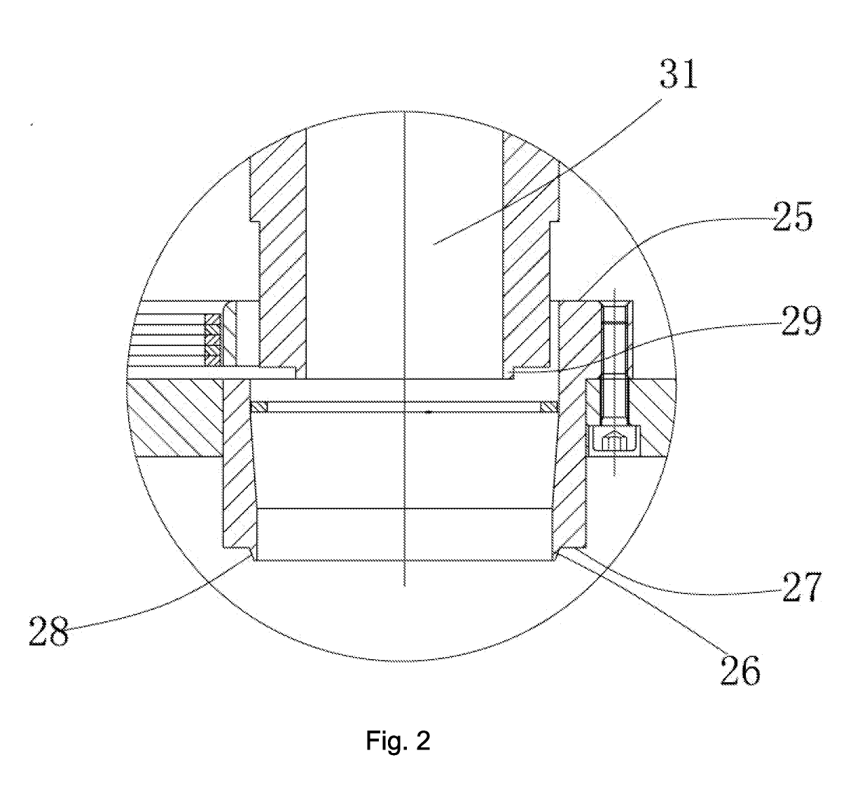

As shown in FIG. 1 and FIG. 2, the bottom of the circlip core rod 9 forms a cavity 31. The middle of the circlip core rod 9 is provided with an annular step surface 24. The annular step surface 24 can contact with the top surface 25 of the sleeve 12. The bottom 26 of the sleeve 12 forms an edge 27 rounding with an outer cone shape 28. The bottom of the circlip core rod 9 forms an annular convex shoulder 29 having an outer diameter matching the inner diameter of a contracted same of the circlip. An orientation board 30 for a work piece is fixed on the base board 1 at where is under and aimed at the sleeve 12.

Before mounting, as shown in FIG. 1, it is necessary to put the circlip 33 inside the sleeve 12 and to position the work piece 32 (In FIG. 1, the work piece 32 is an electromotor casing.) on the orientation board 30. Push the feeding board 20 by the handle 21 and the feeding board 20 pushes the circlip 33 at the bottom of the circlip storage 18 inside the sleeve 12. Start the cylinder 7 and the piston rod 8 will push the circlip core rod 9 and core rod fixation board 4 to move downwards along the two sliding guides 2. The sleeve fixation board 5 will also move downwards under the action of the two compression springs 6. The bottom of the sleeve 12 will firstly contact the top surface of the work piece 32 and pre-compress the work piece 32, the inner cone hole 15 of the sleeve 12 and the internal chamber of the work piece 32 will perforate. The bottom 26 of the sleeve 12 will enter into the work piece 32 to enable the bottom 26 of the sleeve 12 to be directly close to the groove 34 which located in the internal chamber of the work piece 32. The circlip core rod 9 keeps moving downwards under the drive of the piston rod 8 and its bottom will contact the end face of circlip 33 and press ii the circlip 33 to the bottom of the inner cone hole 15 of the sleeve 12. The circlip 33 will contract as a result. With the continuous movement of the circlip core rod 9, the contracted circlip 33 will be moved to the groove 34 of the work piece and stretched out under its own elastic force. When the cylinder returns, it will repeat the above movement.

1. A mounting device for internal circlip comprising:
a device frame composed of a base board, a cylinder fixation board and at least two perpendicular sliding guides located between the base board and the cylinder fixation board and fixed thereof;
a core rod fixation board and a sleeve fixation board being movable on the at least two sliding guides, the core rod fixation board being above the sleeve fixation board, at least two compression springs being located thereof;
a cylinder fixed on the cylinder fixation board, a piston rod of the cylinder passing through the cylinder fixation board being fixed on top of a circlip core rod, the circlip core rod and the core rod fixation board being fixed together and a bottom of the circlip core rod extending to a top of the sleeve fixation board;
a sleeve coaxial with the circlip core rod being fixed on the top of the sleeve fixation board, the sleeve having a inner cone hole with a big top opening and a small bottom opening, a bottom of the circlip core rod can pass through the small bottom opening of the inner cone hole, and an orientation board for a work piece being fixed on the base board at where is under and aimed at the sleeve.

2. The mounting device for internal circlip according to claim 1, wherein a circlip storage is provided on the top surface of the sleeve fixation board beside the sleeve, the circlip storage has a guide board matching a opening of the circlip, a feeding board having a smaller thickness than the circlip axial is movable between the guide board and the sleeve fixation board, the sleeve has an entrance allowing the feeding board to insert.

3. The mounting device for internal circlip according to claim 1, wherein the middle of said circlip core rod is provided with an annular step surface, which can contact with the top surface of the sleeve.

4. The mounting device for internal circlip according to claim 1, wherein the bottom of said sleeve forms an edge rounding with an outer cone shape.

5. The mounting device for internal circlip according to claim 1, wherein the bottom of said circlip core rod forms an annular convex shoulder having an outer diameter matching the inner diameter of a contracted same of the circlip.

6. The mounting device for internal circlip according to claim 1, wherein the inner cone hole of the sleeve has a cylindrical section at the big top opening and a cylindrical section at the small bottom opening.

7. The mounting device for internal circlip according to claim 1, wherein the bottom of said circlip core rod forms a cavity and the top of the circlip core rod is connected with the piston rod of the cylinder by screw connection.

8. The mounting device for internal circlip according to claim 1, wherein said core rod fixation board has a core rod mounting hole, the circlip core rod having a shoulder is put in the core rod mounting hole , then is fixed with the core rod fixation board together by bolts.

9. The mounting device for internal circlip according to claim 1, wherein said sleeve fixation board has a sleeve mounting hole, the sleeve with a shoulder is put in the sleeve mounting hole, then is fixed with the sleeve fixation board together by bolts.

10. The mounting device for internal circlip according to claim 2, wherein the middle of said circlip core rod is provided with an annular step surface, which can contact with the top surface of the sleeve.

11. The mounting device for internal circlip according to claim 2, wherein the bottom of said sleeve forms an edge rounding with an outer cone shape.

12. The mounting device for internal circlip according to claim 2, wherein the bottom of said circlip core rod forms an annular convex shoulder having an outer diameter matching the inner diameter of a contracted same of the circlip.

13. The mounting device for internal circlip according to claim 2, wherein the inner cone hole of the sleeve has a cylindrical section at the big top opening and a cylindrical section at the small bottom opening.

14. The mounting device for internal circlip according to claim 2, wherein the bottom of said circlip core rod forms a cavity and the top of the circlip core rod is connected with the piston rod of the cylinder by screw connection.

15. The mounting device for internal circlip according to claim 2, wherein said core rod fixation board has a core rod mounting hole, the circlip core rod having a shoulder is put in the core rod mounting hole , then is fixed with the core rod fixation board together by bolts.

16. The mounting device for internal circlip according to claim 2, wherein said sleeve fixation board has a sleeve mounting hole, the sleeve with a shoulder is put in the sleeve mounting hole, then is fixed with the sleeve fixation board together by bolts.
